(19) United States
(12) Patent Application Publication
(10) Pub. No.: US 2016/0085306 A1
(43) Pub. Date: Mar. 24, 2016

(54) DISPLAY DEVICE COMPRISING A NOTABLY HAPTIC TOUCH SURFACE AND A FLEXIBLE ELECTRICAL SHIELD

(71) Applicant: THALES, Courbevoie (FR)

(72) Inventors: Laurent MOZER, Merignac (FR); Marina FLOUREZ, Talence (FR); Pascal ABOMNES, Saint Medard en Jalles (FR)

(21) Appl. No.: 14/862,109

(22) Filed: Sep. 22, 2015

(30) Foreign Application Priority Data
Sep. 22, 2014 (FR) 1402111

(51) Int. Cl. G06F 3/01; G06F 3/041

(52) U.S. Cl. CPC G06F 3/016; G06F 3/0412; G06F 2203/04103; G06F 2203/04107

(57) ABSTRACT

The general field of the invention is that of flat-screen display devices comprising a touch surface. Such a device comprises a conductive mechanical holder in which are housed:
on the bottom of the holder, a display panel comprising, on its upper face, a transparent electrical shielding film of dimensions substantially identical to those of the matrix panel; and
a touch panel of dimensions substantially identical to those of the display panel, said touch panel being located above said display panel, its lower face being placed just above the shielding film.

The display device according to the invention comprises a flexible conductive film that forms the ground path between the electrical shielding film and the bottom of the conductive mechanical holder, the conductive film and the shielding film making contact on the periphery of the display panel.

The field of the invention is that of display devices comprising a transparent display matrix and a touch surface, the device possibly being haptic. The preferred field of application is aeronautics and the display systems of cockpits.

Generally, a flat-screen display device comprises a glass panel placed in a metal holder. There are various types of display devices. Mention may notably be made of liquid-crystal (or LCD) devices. It is necessary, in a certain number of applications where the electromagnetic environment may be highly disturbed, to electrically shield the front sides of display devices so as to limit electromagnetic problems.

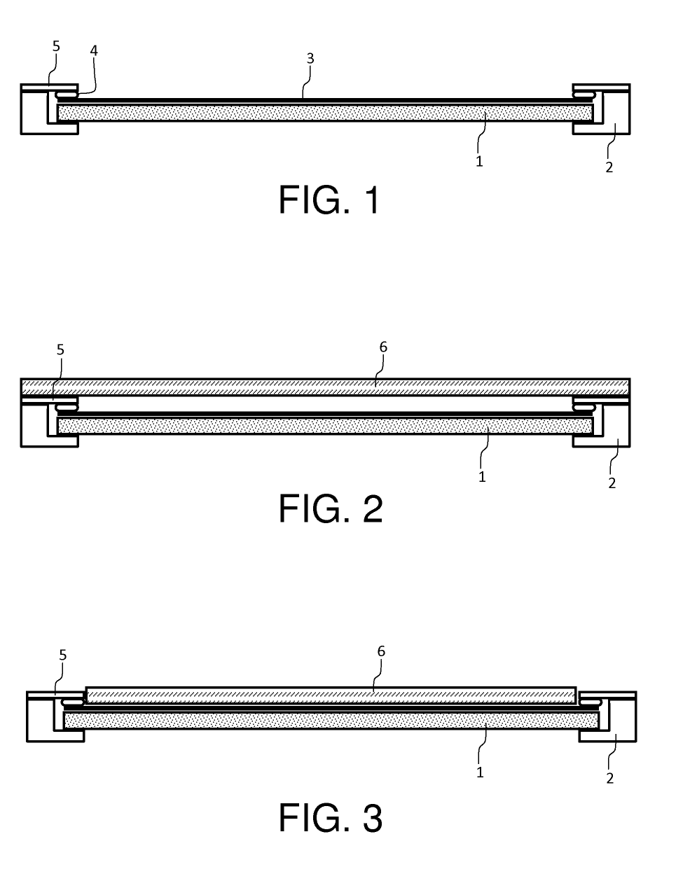

There are various ways of shielding the glass panel, which must remain transparent. Mention may be made, inter alia, of the use of indium tin oxide (ITO) coatings or treatments, conductive micromesh films, films containing carbon nanotubes, and metal deposits containing coalesced silver. This shield, to be effective, must be connected to the metal holder. Generally, as illustrated in FIG. 1, which shows a cross-sectional view of a glass display panel 1 in its holder 2, the shield 3 is grounded via an electromagnetically compatible (EMC) shielding seal 4 held by a metal frame 5 fastened to the main holder of the glass panel 1. This solution gives good results providing that the shielding seal makes direct contact with the shield.

Currently, in many applications, the display device comprises a touch panel placed above the glass panel used for the display. To ensure shielding continuity, there exist various possible solutions. The first solution is illustrated in FIG. 2. It consists in adding the touch panel 6 above the preceding metal frame 5. As may be seen in FIG. 2, there is therefore an air gap between the glass panel and the touch panel. This air gap has a number of drawbacks. The mechanical withstand of the assembly is not excellent. In addition, the touch panel introduces additional reflections and causes a loss of optical transmission.

The second solution consists in adhesively bonding the touch panel 6 to the shield without modifying the preceding architecture, thus eliminating the problems due to the air gap. This solution is illustrated in FIG. 3. It is disadvantageous in terms of compactness.

The display device according to the invention does not have these drawbacks. Its main feature is that the grounding is no longer achieved via a peripheral seal but rather via a thin flexible conductive film. More precisely, the subject of the invention is a flat-screen display device comprising a touch surface, said device comprising at least one conductive mechanical holder in which are housed:
on the bottom of the holder, a matrix display panel comprising, on its upper face, a transparent electrical shielding film of dimensions substantially identical to those of the matrix panel; and
a touch panel of dimensions substantially identical to those of the matrix display panel, said touch panel being located above said matrix display panel, its lower face being placed just above the shielding film;
characterised in that a flexible conductive film is used to form the ground path between the electrical shielding film and the bottom of the conductive mechanical holder, the flexible conductive film and the shielding film making contact on the periphery of the matrix display panel.

Advantageously, the conductive film is fastened to the electrical shielding film by means of a conductive glue or a conductive adhesive or a conductive ink.

Advantageously, the conductive film is a metallised nylon fabric.

Advantageously, the matrix display panel is a liquid-crystal panel or an organic light-emitting diode panel or a matrix of electromechanical micro-mirrors.

The invention also relates to a display device such as described above and comprising a haptic function ensured by vibrating means placed between the matrix display panel and the bottom of the holder, the conductive film being flexible enough not to interfere with the movements of the matrix display panel due to the haptic effect.

The invention will be better understood and other advantages will become apparent on reading the following nonlimiting description given with reference to the appended figures, in which:

FIG. 1 shows a display device without a touch panel and grounded according to the prior art;

FIG. 2 shows a first display device configuration comprising a touch panel and grounded according to the prior art;

FIG. 3 shows a second display device configuration comprising a touch panel and grounded according to the prior art;

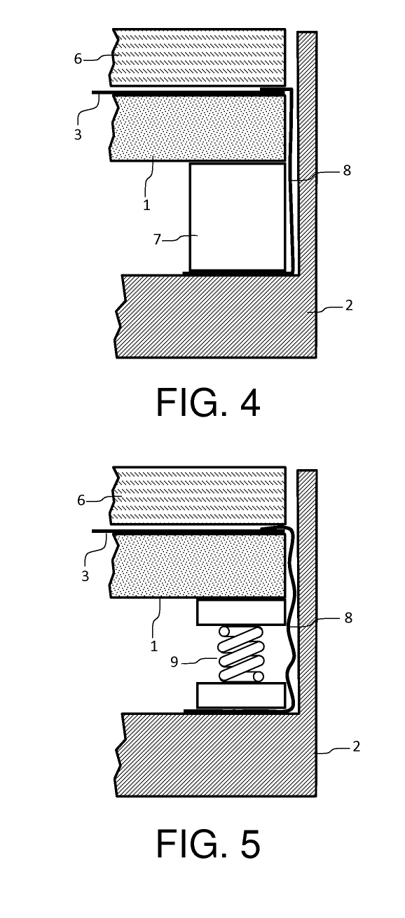

FIG. 4 shows a display device comprising a touch panel and grounded according to the invention; and

FIG. 5 shows a display device comprising a touch screen and haptic functions and grounded according to the invention.

FIG. 4 shows a partial cross-sectional view of a display device according to the invention. It comprises an electrically conductive mechanical holder 2. This holder 2 comprises a bottom and side walls in which are housed:
a matrix display panel 1 comprising, on its upper face, a transparent electrical shielding film 3 of dimensions substantially identical to those of the matrix panel. In FIG. 4, said touch panel rests on a metal spacer 7;
a touch panel 6 of dimensions substantially identical to those of the matrix display panel 1, said touch panel being located above said matrix display panel, its lower face being placed just above the shielding film 3; and
a flexible conductive film 8 that is used to form the ground path between the electrical shielding film and the bottom of conductive mechanical holder 2, the flexible conductive film 8 and the shielding film 3 making contact on the periphery of the matrix display panel. The shielding film is slid along the side walls of the mechanical holder 2.

By way of example, the conductive film is a metallised nylon fabric.

The conductive film is fastened to the electrical shielding film by means of a conductive glue or a conductive adhesive or even a conductive ink. These solutions are conventionally implemented in flexible or “flex” electrical connections or in the flexible tabs of liquid-crystal display matrices. It is also possible to use staples or one of the sewn fastenings conventionally used with fabrics.

The flexible film is connected either at discrete points or continuously to the bottom of the holder or its metal spacer and hence to ground, as shown in FIG. 4.

The display device may comprise a haptic function ensured by vibrating means placed between the matrix display panel and the bottom of the holder. FIG. 5 illustrates this arrangement. The haptic means 9 are symbolised by a spring in FIG. 5. The conductive film is chosen to be flexible enough not to interfere with the movements of the matrix display panel due to the haptic effect.

The advantages of the shield grounding according to the invention in a display device containing a touch panel are essentially:
device simplicity;
simplicity of implementation;
excellent electrical ground continuity;
absence of additional occultations both as regards the glass panel and as regards the touch panel;
ease of adaptation to all types of display matrices; and
capacity to operate including in the presence of haptic means.

1. A flat-screen display device comprising a touch surface, said device comprising at least one conductive mechanical holder in which are housed:
on the bottom of the holder, a matrix display panel comprising, on its upper face, a transparent electrical shielding film of dimensions substantially identical to those of the matrix panel; and
a touch panel of dimensions substantially identical to those of the matrix display panel, said touch panel being located above said matrix display panel, its lower face being placed just above the shielding film;
wherein a flexible conductive film is used to form the ground path between the electrical shielding film and the bottom of the conductive mechanical holder, the flexible conductive film and the shielding film making contact on the periphery of the matrix display panel.

2. The display device according to claim 1, wherein the conductive film is fastened to the electrical shielding film by means of a conductive glue or a conductive adhesive or a conductive ink.

3. The display device according to claim 1, wherein the conductive film is a metallised nylon fabric.

4. The display device according to claim 1, wherein the matrix display panel is a liquid-crystal panel or an organic light-emitting diode panel or a matrix of electromechanical micro-mirrors.

5. The display device according to claim 1, wherein the display device comprises a haptic function ensured by vibrating means placed between the matrix display panel and the bottom of the holder, the conductive film being flexible enough not to interfere with the movements of the matrix display panel due to the haptic effect.
